(19) United States
(12) Patent Application Publication
(10) Pub. No.: US 2022/0361048 A1
(43) Pub. Date: Nov. 10, 2022

(54) ASSISTANCE INFORMATION METHODS FOR SIDELINK CARRIER AGGREGATION

(71) Applicant: QUALCOMM Incorporated, San Diego, CA (US)

(72) Inventors: Anantharaman BALASUBRAMANIAN, San Diego, CA (US); Shuanshuan WU, San Diego, CA (US); Kapil GULATI, Belle Mead, NJ (US)

(21) Appl. No.: 17/308,034

(22) Filed: May 4, 2021

(51) Int. Cl. H04W 28/26; H04L 5/00; H04W 24/08; H04W 72/04

(52) U.S. Cl. CPC H04W 28/26; H04L 5/0053; H04W 24/08; H04W 72/0406; H04W 92/18

(57) ABSTRACT

Certain aspects of the present disclosure provide a method for wireless communications by a first UE. The method generally includes obtaining carrier assistance information indicating information for a future channel busy ratio (FCBR) one or more carriers on which at least a second UE is operating and performing carrier selection for sidelink transmissions, based on the carrier assistance information.

### FIELD OF THE DISCLOSURE

Aspects of the present disclosure relate to wireless communications, and more particularly, to techniques for facilitating sidelink communications.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved acknowledgment feedback transmission for sidelink communications.

Certain aspects of the subject matter described in this disclosure can be implemented in a method for wireless communications by a network entity. The method generally includes receiving, from at least first and second user equipments (UEs), information regarding future resource reservations for sidelink transmissions on one or more carriers, calculating a metric for each of the carriers, based on the received information, and signaling carrier assistance information to the UEs, based on the metric for each of the carriers.

Certain aspects of the subject matter described in this disclosure can be implemented in a method for wireless communications by a first UE. The method generally includes obtaining carrier assistance information indicating information for a future channel busy ratio (FCBR) one or more carriers on which at least a second UE is operating and performing carrier selection for sidelink transmissions, based on the carrier assistance information.

Aspects of the present disclosure provide UEs, network entities, means for, apparatuses, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4A and FIG. 4B illustrate diagrammatic representations of example vehicle to everything (V2X) systems, in accordance with certain aspects of the present disclosure.

FIG. 5 illustrates example operations for wireless communications by a network entity, in accordance with certain aspects of the present disclosure.

FIG. 6 illustrates example operations for wireless communications by a first UE, in accordance with certain aspects of the present disclosure.

FIG. 7 illustrates a call flow diagram for facilitating sidelink communications, in accordance with certain aspects of the present disclosure.

FIG. 8 illustrates example future channel busy ratio (FCBR) information, in accordance with certain aspects of the present disclosure.

FIG. 9 illustrates a communications device that may include various components configured to perform operations for techniques disclosed herein in accordance with aspects of the present disclosure.

FIG. 10 illustrates a communications device that may include various components configured to perform operations for techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques for facilitate sidelink communications in systems that utilize carrier aggregation (CA).

In some systems, CA may be deployed where several carriers are used concurrently to improve capacity of the system. Similar CA techniques can be used for sidelink communications, to enable high bandwidth V2X use cases, such as sensor sharing (e.g., data sharing for camera images, radar, LIDAR, and the like).

CA has been adopted in LTE-based sidelink, where several carriers can be active concurrently based on the applications used. In LTE, there is typically a carrier to application mapping performed at higher layers (e.g., layers higher than physical PHY and/or medium access control MAC layers). Further, there may be constraints on using a single carrier for an application.

For NR use cases (e.g., sensor sharing), it may be desirable to have multiple carriers for supporting an application. Further, the UEs may have transmission constraints. For example, the number of carriers that UEs can transmit on may be less than the number of available carriers for an application.

Aspects of the present disclosure provide signaling mechanisms that allow UEs the ability to infer which carriers are less congested for transmitting their packets.

The following description provides examples of such signaling mechanisms and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

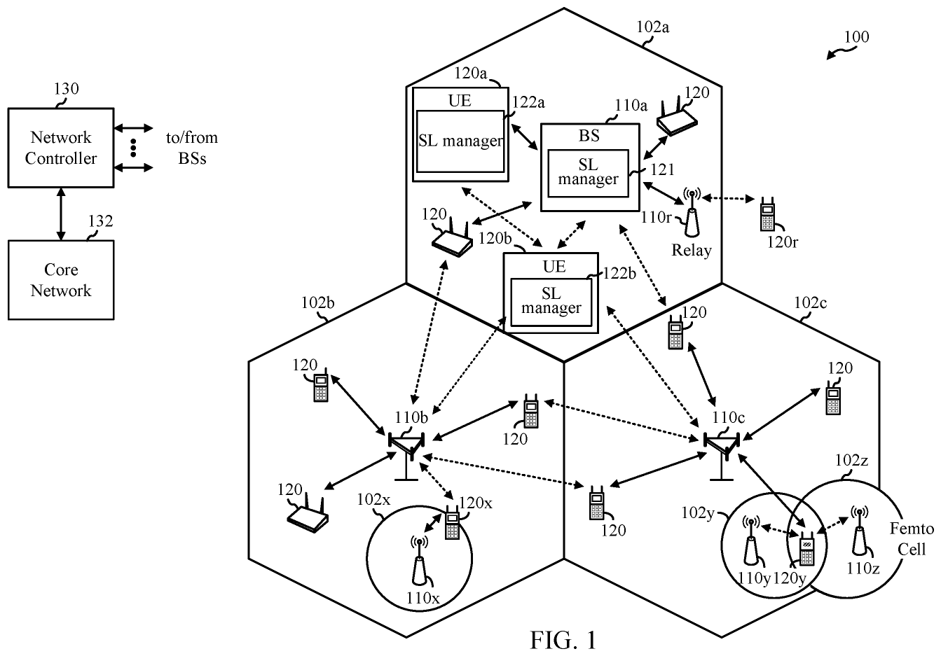

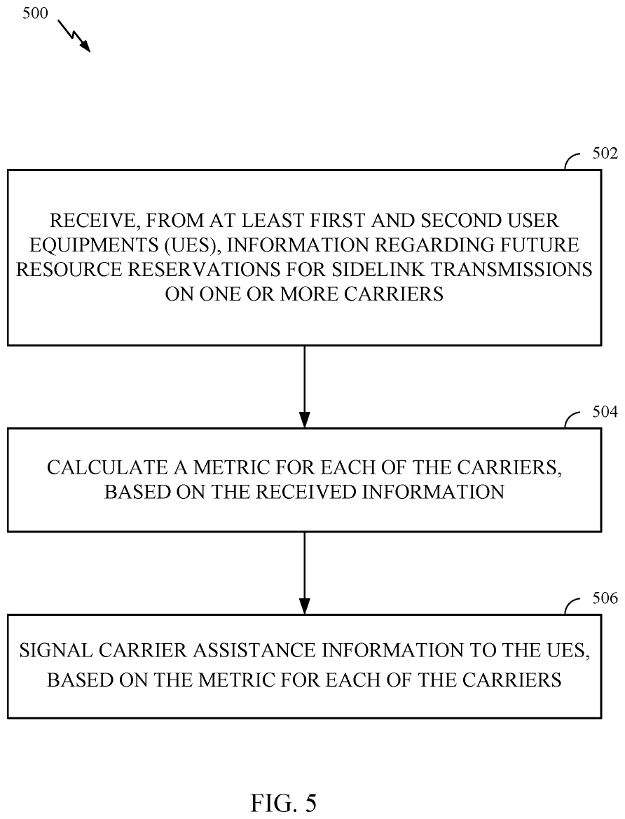

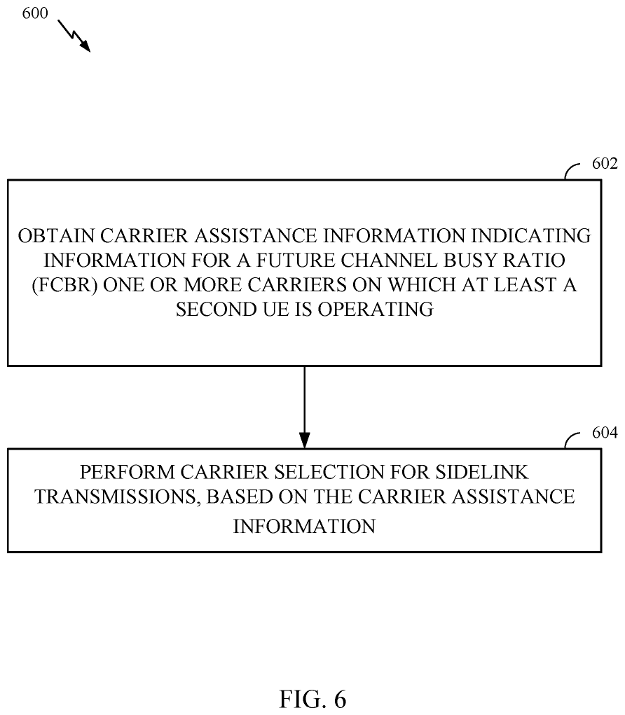

FIG. 1 is a block diagram conceptually illustrating an example wireless communication network 100, in which certain aspects of the present disclosure may be practiced. For example, the wireless communication network 100 may include UEs 120a and 120b that include, among other modules/managers, sidelink (SL) managers 122a and 122b, respectively, configured to perform operations 600 of FIG. 6. Similarly, the wireless communication network 100 may include a BS 110a that includes, among other modules/managers, an SL manager 121, configured to perform operations 500 of FIG. 5.

Wireless communication network 100 may be, for example, an NR system (e.g., a 5G NR network). As shown in FIG. 1, the wireless communication network 100 may be in communication with a core network 132. The core network 132 may in communication with one or more base station (BSs) 110 and/or user equipments (UEs) 120 in the wireless communication network 100 via one or more interfaces.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

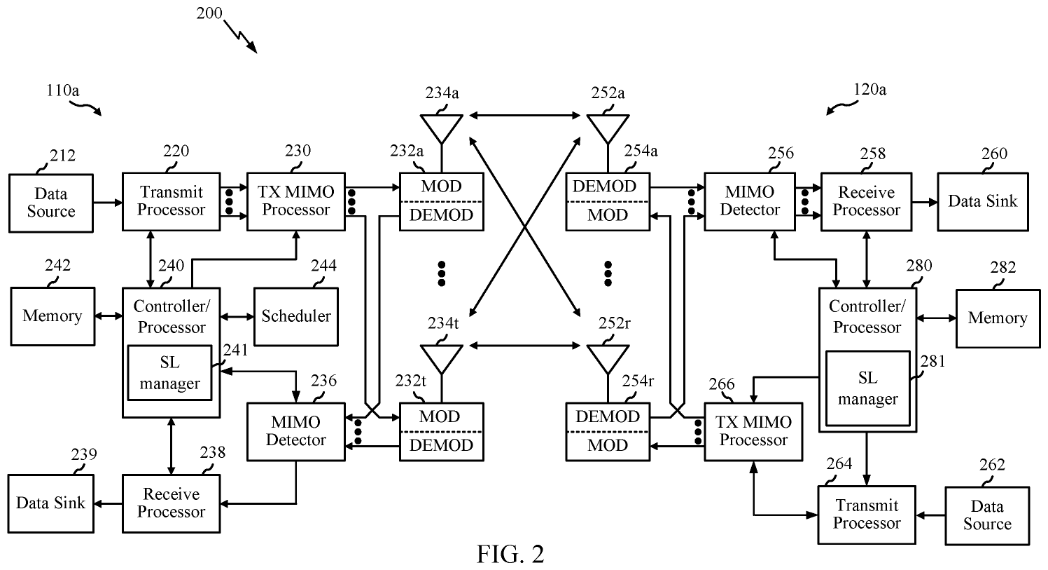

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 280 of the UE 120a may have an SL manager 281 configured to perform operations 600 of FIG. 6. Similarly, as shown in FIG. 2, the controller/processor 240 of the BS 110a may have an SL manager 241 configured to perform operations 500 of FIG. 5. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

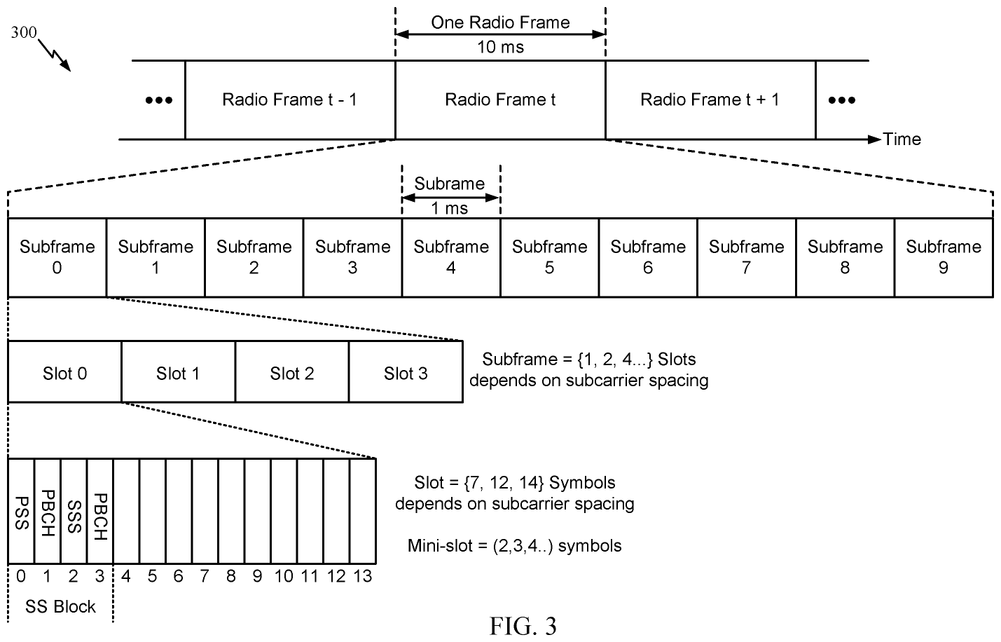

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, while the SS may provide the CP length and frame timing. The PSS and SSS may provide the cell identity. The PBCH carries some basic system information, such as downlink system bandwidth, timing information within radio frame, SS burst set periodicity, system frame number, etc.

The SSBs may be organized into SS bursts to support beam sweeping. Further system information, such as remaining minimum system information (RMSI), system information blocks (SIBs), other system information (OSI) may be transmitted on a physical downlink shared channel (PDSCH) in certain subframes. The SSB may be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets may be transmitted at different frequency regions.

In some examples, the communication between the UEs 120 and BSs 110 is referred to as the access link. The access link may be provided via a Uu interface. Communication between devices may be referred as the sidelink.

### Introduction to Sidelink Communications

In New Radio (NR), a user equipment (UE) may exchange sidelink data (e.g., user data and control signaling) with other UEs directly and without the help (e.g., relaying) of a base station. This type of sidelink communication is often called peer-to-peer (also referred to as device-to-device or D2D) communication. An example of peer-to-peer communication includes vehicle to everything (V2X) communication where a vehicle may communicate with another vehicle (V2V) or a different device, such as a base station, a traffic control system, or the like.

In some examples, two or more subordinate entities (e.g., UEs 120) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE 120a, as shown in FIG. 1) to another subordinate entity (e.g., UE 122a UE 120) without relaying that communication through the scheduling entity (e.g., UE 120 or BS 110), even though the scheduling entity may be utilized for scheduling and/or control purposes. In some examples, the sidelink signals may be communicated using a licensed spectrum (unlike wireless local area networks, which typically use an unlicensed spectrum). One example of sidelink communication is PC5, for example, as used in V2V, LTE, and/or NR.

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling, such as sidelink resource configurations and other parameters used for data transmissions, and the PSSCH may carry the data transmissions. The PSFCH may carry sidelink feedbacks, such as distance-based and/or non-distance-based HARQ feedbacks related to data transmissions between two or more UEs that are in direct communication with each other.

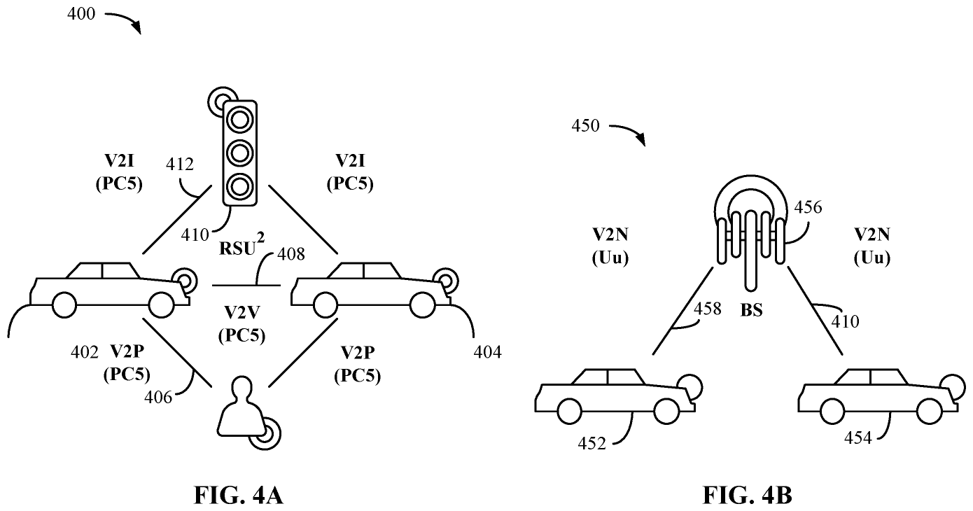

FIG. 4A and FIG. 4B show diagrammatic representations of example V2X systems, in accordance with some aspects of the present disclosure. For example, the vehicles shown in FIG. 4A and FIG. 4B may perform data transmissions via sidelink channels and may receive sidelink feedbacks regarding those data transmissions, as described herein.

The V2X systems that are shown in FIG. 4A and FIG. 4B provide two complementary transmission modes. A first transmission mode, shown by way of example in FIG. 4A, may involve direct communications (may also be referred to as sidelink communications) between participants in proximity to one another in a local area. Sidelink transmissions by the UEs (e.g., Vehicles 402 and 404, or traffic light 410) may implemented over a PC5 interface (e.g., a wireless communication interface between a first UE and a second UE). A second transmission mode, shown by way of example in FIG. 4B, may involve network communications through a network, which may be implemented over a Uu interface (e.g., a wireless communication interface between a radio access network (RAN) and a UE).

Referring to FIG. 4A, a V2X system 400 (e.g., vehicle to vehicle (V2V) communications) is illustrated with two vehicles 402, 404. The first transmission mode allows for direct communication between different participants in a given geographic location. As illustrated, a vehicle can have a wireless communication link 406 with an individual (V2P) (e.g., with a mobile phone of the individual) through a PC5 interface. Communications between the vehicles 402 and 404 may also occur through a PC5 interface 408. In a like manner, communication may occur from a vehicle 402 to other highway components (e.g., highway component 410), such as a traffic signal or sign (V2I) through a PC5 interface 412. With respect to each communication link illustrated in FIG. 4A, two-way communication may take place between elements, therefore each element may be a transmitter and a receiver of information.

The V2X system 400 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed and/or unlicensed spectrum, thus any vehicle with an equipped system may access a common frequency and share information. Such harmonized/common spectrum operations may allow for safe and reliable operations.

FIG. 4B shows a V2X system 450 for communication between a vehicle 452 and a vehicle 454 through a network entity 456. These network communications may occur through discrete nodes, such as a BS (e.g., the BS 110a shown in FIG. 1), that sends and receives information to and from (or relays information between) vehicles 452, 454. The network communications through vehicle to network (V2N) links 458 and 410 may be used, for example, for long range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

For sidelink communications, resources may be allocated differently in different modes. In a first mode, Mode 1 sidelink communication, the sidelink resources are often scheduled by a gNB. In a second mode, Mode 2 sidelink communication, the UE may autonomously select sidelink resources from a (pre)configured sidelink resource pool(s) based on the channel sensing mechanism. When the UE is in-coverage, a gNB may be configured to adopt Mode 1 or Mode 2. When the UE is out of coverage, only Mode 2 may be adopted.

When operating in Mode 1, in an unlicensed spectrum (NR-Unlicensed or NR-U) the gNB assigns orthogonal resources for transmitter UEs for their transmissions. In unlicensed spectrum, however, the transmitter UE still has to perform a listen before talk (LBT) procedure before transmitting. In the event of failure of the LBT procedure, the transmitter UE may need an additional DCI grant from gNB, resulting in additional control signal overhead and extra delay. Aspects of the present disclosure may help address this potential LBT issue for gNB based scheduling or NR-U sidelink transmissions in Mode 1.

### Example Assistance Information Signaling for Sidelink CA

Aspects of the present disclosure relate to wireless communications, and more particularly, to techniques for facilitate sidelink communications.

As noted above, for CA use cases, several carriers may be used concurrently to enable high bandwidth V2X use cases, such as sensor sharing. In such cases, in order to perform carrier selection, UEs should be able to infer which carriers are less congested for transmitting their packets.

In some CA scenarios, a UE may be under the coverage of a gNB and allowed to transmit in n carriers: {C1,C2,C3, . . . Cn}, based on one or more applications it is subscribed/operating on. However, the UE may only be capable of transmitting in m carriers at a time instance (where m<n). This may be due to contiguous or non-contiguous allocation of carriers for that application and/or may be due other constraints.

Such scenarios present a challenge regarding UE resource selection for sidelink communications. In other words, it may not be clear how a UE is to select resources (e.g., which carriers) for sidelink communications or how a gNB might signal the UEs for enabling application specific carrier reselection.

In some CA scenarios, UEs may not be in the coverage of a gNB. In such cases, the UEs may operate in a distributed manner. This scenario also presents a challenge in carrier selection.

Aspects of the present disclosure provide techniques, however, that may enable UEs to cooperate with each other (and/or a gNB) to enable carrier reselection.

As will be described in greater detail below, in some cases, a gNB may request a UE to perform future channel busy ratio CBR (FCBR) measurements on a subset of carriers. From the measurement report the gNB obtains from different UEs on a different set of carriers, the gNB may be able to assist with the appropriate carrier selection for different set of UEs.

In some cases, the gNB may decode the SCI on different sets of carriers and may be able to infer future CBR autonomously, based on which is able to assist each UE on carrier reselection.

According to certain aspects, each UE may infer the future CBR (FCBR) of each carrier and may perform inter-carrier assistance, by transmitting this information on to a different carrier (e.g., in a medium access control element or MAC-CE) for carrier reselection assistance.

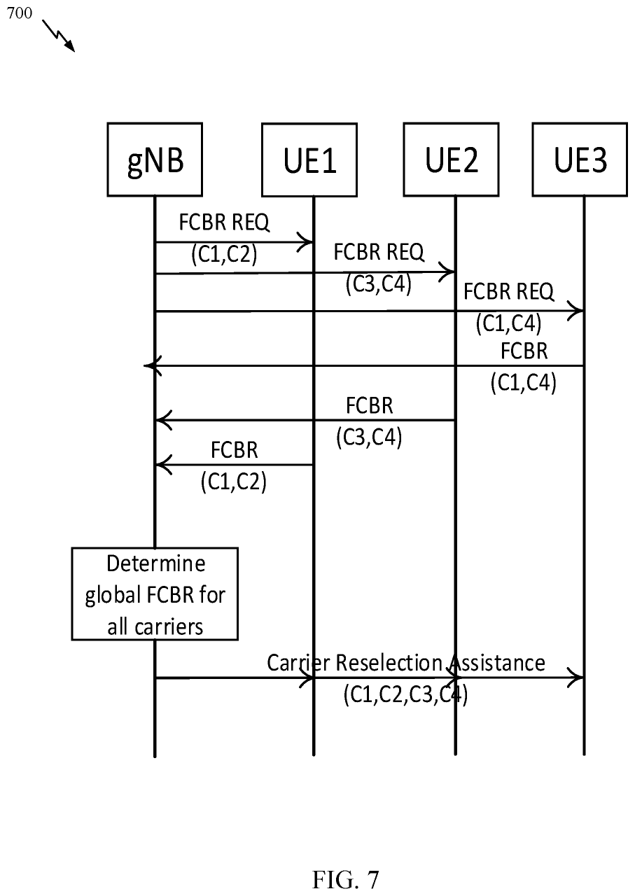

FIG. 5 illustrates example operations 500 for wireless communications by a network entity, in accordance with certain aspects of the present disclosure. Operations 500 may be performed, for example, by a base station (e.g., BS 110 in the wireless communication network 100, as shown in FIG. 1), to signal assistance information to aid one or more UEs (e.g., UE1, UE2, and UE3 of FIG. 7 performing operations 600 of FIG. 6) in performing sidelink carrier aggregation.

Operations 500 begin, at 502, by receiving, from at least first and second user equipments (UEs), information regarding future resource reservations for sidelink transmissions on one or more carriers.

At 504, the network entity calculates a metric (e.g., an aggregate/global FCBR) for each of the carriers, based on the received information. At 506, the network entity signals carrier assistance information to the UEs, based on the metric for each of the carriers.

FIG. 6 illustrates example operations 600 for wireless communications by a first UE that may be considered complementary to operations 500 of FIG. 5. For example, operations 600 may be performed by a UE (e.g., UE1, UE2, or UE3 of FIG. 7) to select one or more carriers for transmitting sidelink data based on assistance information provided by a gNB (performing operations 500 of FIG. 5).

Operations 600 begin, at 602, by obtaining carrier assistance information indicating information for a future channel busy ratio (FCBR) one or more carriers on which at least a second UE is operating. At 604, the first UE performs carrier selection for sidelink transmissions, based on the carrier assistance information.

Operations 500 and 600 of FIGS. 5 and 6 may be understood with reference to the call flow diagram 700 of FIG. 7 for Mode-1 based carrier reselection assistance.

As illustrated in FIG. 7, in some cases, the gNB may first send each UE an FCBR request. For example, the gNB may signal the request in DCI to the UEs. Each request may indicate a subset of carriers for which that UE is to report FCBR information. In response, each UE provides the measurement report for a different set of carriers. This information provided by the UEs enables the gNB to obtain the global future CBR measurement of all carriers. The gNB then signals each UE the appropriate carrier selection assistance information.

In the example illustrated in FIG. 7, the gNB requests UE1 to report FCBR for carriers C1 and C2, requests UE2 to report FCBR for carriers C3 and C4, and request UE3 to report FCBR for carriers C1 and C4. In general, FCBR may be calculated based on future resource reservations inferred by a UE, or may indicate the resource reservations performed by one or more UE. A UE may infer future resource reservations based on sidelink control information (SCI) of all UEs) on a carrier for a given time interval [t₁, t₁+T₁], where t₁ is the time at which this FCBR would be reported by this UE to the gNB.

From the individual FCBR reported by UE1, UE2, UE3 for each carrier, the gNB may infer global FCBR for the time duration [t₂, t₂+T₂]. Based on the global FCBR of each carrier, and the applications mapping/preferences, the UE is performing, the gNB may signal optimal carrier assistance information to UE1, UE2, UE3 for time [t₃, t₃+T₃]. Each UE may use this information for carrier selection.

In one case, the gNB may decode the SCI of one or more subset of UEs operating in one or more subsets of all carriers C={C1,C2,C3, . . . Cn} in order to infer the global FCBR of C. The gNB may decode the SCI as an alternative, or in addition, to requesting FCBR from each of the UEs. Based on the global FCBR of each carrier, and the applications mapping/preferences of UE, the gNB signals carrier assistance information to each UE.

For example, the gNB may decode the SCI of UE1 operating in {C1, C2}, of UE2 operating in {C3, C4}, and of UE3 operating in {C4, C1}. From this decoded information, the gNB may infer the future resource reservation of UE1, U2, and U3 in time interval [t, t₃+T]. Based on this future resource reservation information, the gNB may calculate the expected FCBR of carriers {C1, C2, C3, C4}. The gNB may then signal the carrier selection information/global FCBR of all carriers to UE1, UE2, and UE3.

For Mode-2 based carrier reselection assistance, UEs may coordinate and share information between themselves. For example, each UE operating in a first set of carriers may transmit the FCBR information in the second set of carriers (where the second set of carriers is a subset of first set of carriers).

In one case, the FCBR information for all carriers may be transmitted explicitly as a part of carrier assistance information, or as part of SCI. In one case, the FCBR information may be included (piggybacked) as a part of MAC-CE.

Mode-2 based carrier reselection assistance may be understood by considering an example where UE1, UE2, and UE3 can transmit in any of carriers {C1,C2,C3,C4}, but assuming current operation is as follows: UE1 is operating in carriers: {C1,C2,C3}; UE2 is operating in carriers: {C2,C3,C4}; and UE3 is operating in carriers {C2}.

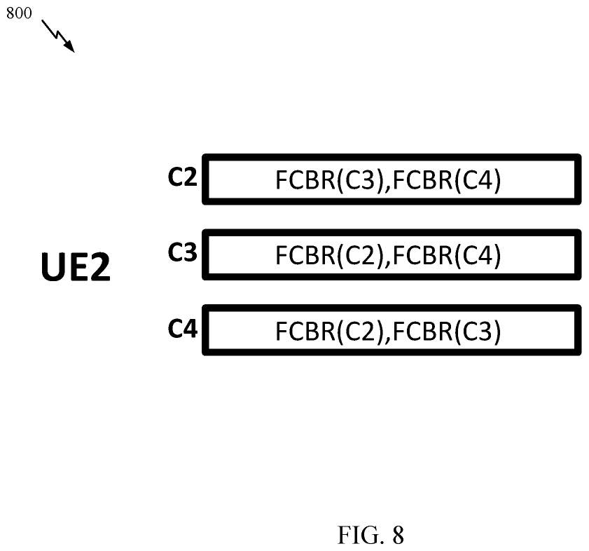

FIG. 8 illustrates FCBR that UE2 may gather and report. For example, UE2 may decode the SCIs that are transmitted in C2 (by UE1, UE3) to infer the future resource reservations in time interval [t₃, t₃+T], Based on this information, UE2 may calculate the FCBR for C2. The FCBR inferred by UE2 in carrier C2 is labeled as FCBR (C2) in FIG. 8. Similarly, UE2 determines FCBR (C3), and FCBR (C4) by decoding SCIs that are transmitted in C3 and C4, respectively.

As shown in FIG. 8, UE2 transmits FCBR (C2) in C3 and C4, transmits FCBR (C3) in C2 and C4, and transmits FCBR (C4) in C2 and C3. This FCBR information may be transmitted as a part of carrier assistance information or piggybacked through a medium access control (MAC) control element (MAC-CE).

Inherently, UE3 would not be aware of FCBR (C3) and FCBR (C4), as it is operating in C2 only (in the example above). However, with UE2 transmitting this information in C2 (as noted above), UE3 becomes aware of the carrier assistance information of C3, C4 (while operating in carrier C2). With this carrier assistance information of C3 and C4 available in C2, UE3 is now in a position to reselect to C3 and/or C4 in an informed way.

Similar operations (as described above with reference to UE2) may be performed by UE1 and UE3. For example, UE1 may report FCBR (C2) and FCBR (C3) on C1, may report FCBR (C1) and FCBR (C3) on C2, and may report FCBR (C1) and FCBR (C2) on C3.

For Mode-1 based gNB signaling of carrier assistance information, the gNB may receive the FCBR report about carriers from one or more UEs. For example, as described above with reference to FIG. 7, the gNB may receive information about C1 from UE1 and UE2; information about C2 from UE1; information about C3 from UE2; and information about C4 from UE2 and UE3.

The gNB may consolidate the FCBR reports obtained from many UEs about a carrier. For example, for C1, the gNB combines the FCBR reports from UE1 and UE2. In one case, if UE1 reports that resources {a, b} would have RSSI>xdB during [t1, t1+T], and if UE2 reports that resources {b, c} could have RSSI>x dB during [t, t1+T], the gNB may conclude the unavailability of resources {a, b, c} in C1 during [t1, t1+T]. Based on this conclusion, the gNB may calculates FCBR of C1 to be the ratio of resources occupied in [t1 t1+T] to the total number of resources that can be available in [t1, t1+T]. The gNB may similarly calculate FCBR for other carriers C2, C3, and C4.

The gNB may then provide this consolidated FCBR of each carrier in a broadcast message (e.g., in a system information broadcast message) to all UEs.

As an alternative, the gNB may provide only the relevant UE-specific FCBR information as a unicast message to that UE. For example, if UE1 is capable of transmitting in carriers {C1, C4, C5}, the gNB may provide a consolidated FCBR to UE1 with information only for these carriers.

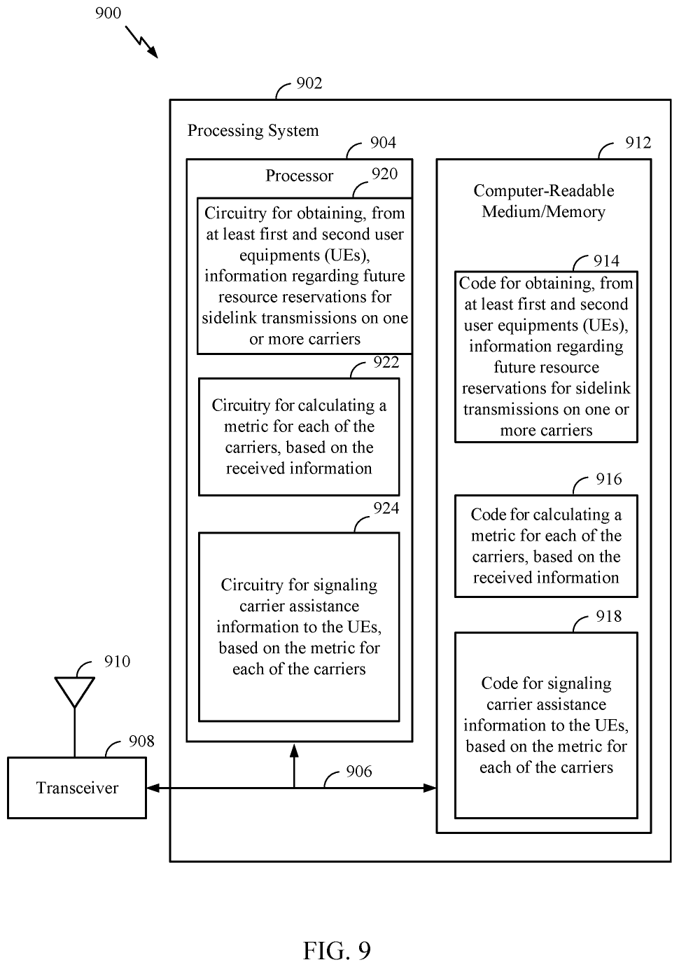

FIG. 9 illustrates a communications device 900 that may include various components (e.g., corresponding to means-plus-function components) configured to perform operations for the techniques disclosed herein, such as the operations illustrated in FIG. 5. The communications device 900 may include a processing system 902 coupled to a transceiver 908 (e.g., a transmitter and/or a receiver). The transceiver 908 may be configured to transmit and receive signals for the communications device 900 via an antenna 910, such as the various signals as described herein. The processing system 902 may be configured to perform processing functions for the communication device 900, including processing signals received and/or to be transmitted by the communications device 900.

The processing system 902 may include a processor 904 coupled to a computer-readable medium/memory 912 via a bus 906. In certain aspects, the computer-readable medium/memory 912 may be configured to store instructions (e.g., computer-executable code) that when executed by the processor 904, cause the processor 904 to perform the operations illustrated in FIG. 5, or other operations for performing the various techniques discussed herein. In certain aspects, computer-readable medium/memory 912 may store code 914 for obtaining, from at least first and second user equipments (UEs), information regarding future resource reservations for sidelink transmissions on one or more carriers; code 916 for calculating a metric for each of the carriers, based on the received information; and/or code 918 for signaling carrier assistance information to the UEs, based on the metric for each of the carriers.

In certain aspects, the processor 904 may have circuitry configured to implement the code stored in the computer-readable medium/memory 912. The processor 904 may include circuitry 920 for obtaining, from at least first and second user equipments (UEs), information regarding future resource reservations for sidelink transmissions on one or more carriers; circuitry 922 for calculating a metric for each of the carriers, based on the received information; and/or circuitry 924 for signaling carrier assistance information to the UEs, based on the metric for each of the carriers.

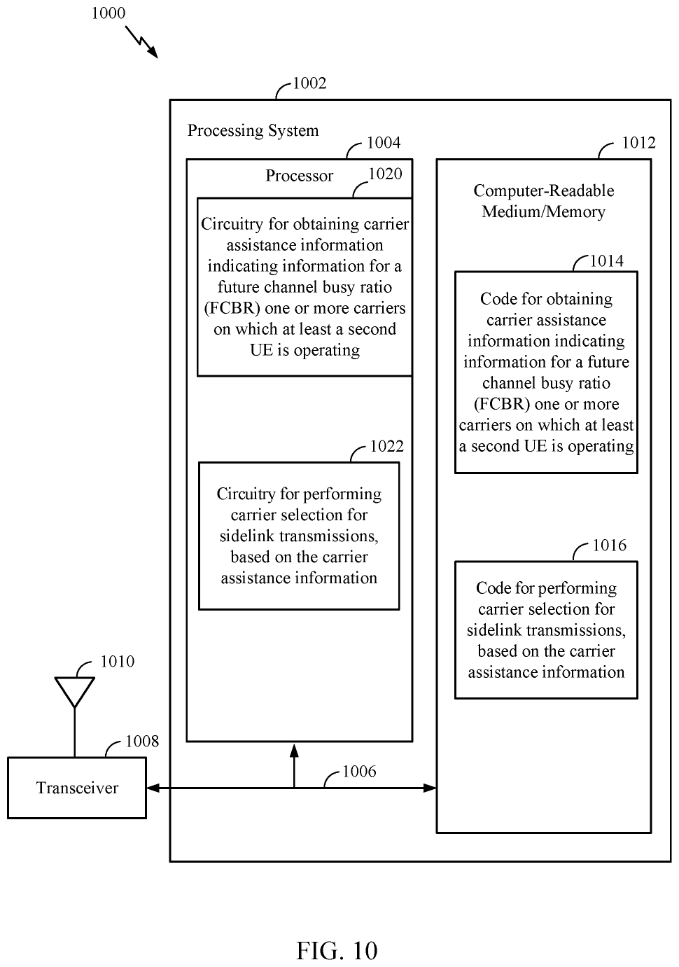

FIG. 10 illustrates a communications device 1000 that may include various components (e.g., corresponding to means-plus-function components) configured to perform operations for the techniques disclosed herein, such as the operations illustrated in FIG. 6. The communications device 1000 may include a processing system 1002 coupled to a transceiver 1008 (e.g., a transmitter and/or a receiver). The transceiver 1008 may be configured to transmit and receive signals for the communications device 1000 via an antenna 1010, such as the various signals as described herein. The processing system 1002 may be configured to perform processing functions for the communication device 1000, including processing signals received and/or to be transmitted by the communications device 1000.

The processing system 1002 may include a processor 1004 coupled to a computer-readable medium/memory 1010 via a bus 1006. In certain aspects, the computer-readable medium/memory 1012 may be configured to store instructions (e.g., computer-executable code) that when executed by the processor 1004, cause the processor 1004 to perform the operations illustrated in FIG. 6, or other operations for performing the various techniques discussed herein. In certain aspects, computer-readable medium/memory 1012 may store code 1014 for obtaining carrier assistance information indicating information for a future channel busy ratio (FCBR) one or more carriers on which at least a second UE is operating; and/or code 1016 for performing carrier selection for sidelink transmissions, based on the carrier assistance information.

In certain aspects, the processor 1004 may have circuitry configured to implement the code stored in the computer-readable medium/memory 1012. The processor 1004 may include circuitry 1020 for obtaining carrier assistance information indicating information for a future channel busy ratio (FCBR) one or more carriers on which at least a second UE is operating; and/or circuitry 1022 for performing carrier selection for sidelink transmissions, based on the carrier assistance information.

### Example Aspects

In addition to the various aspects described above, aspects of specific combinations are within the scope of the disclosure, some of which are detailed below:

Aspect 1: A method for wireless communications by a network entity, comprising: receiving, from at least first and second user equipments (UEs), information regarding future resource reservations for sidelink transmissions on one or more carriers; calculating a metric for each of the carriers, based on the received information; and signaling carrier assistance information to the first and second UEs, based on the metric for each of the carriers.

Aspect 2: The method of Aspect 1, wherein the metric comprises a future channel busy ratio (FCBR).

Aspect 3: The method of Aspect 2, wherein the FCBR is calculated based on future resource reservations inferred by one of the first and second UEs or indicates resource reservations performed by at least one of the first and second UEs.

Aspect 4: The method of any one of Aspects 1-3, wherein: the received information comprises first future channel busy ratio (FCBR) information for at least one of the carriers associated with the first UE and second FCBR information for at least one of the carriers associated with the second UE; the method further comprises consolidating, for each carrier, the first FCBR information and the second FCBR information; and the carrier assistance information comprises the consolidated FCBR information for each carrier.

Aspect 5: The method of Aspect 4, further comprising: signaling a first request for the first UE to provide the first FCBR information; and signaling a second request for the second UE to provide the second FCBR information.

Aspect 6: The method of Aspect 5, wherein: the first request indicates a first one or more carriers on which the first UE is to provide the first FCBR information; and the second request indicates a second one or more carriers on which the second UE is to provide the second FCBR information.

Aspect 7: The method of any one of Aspects 1-6, wherein the carrier assistance information is signaled via a broadcast message.

Aspect 8: The method of any one of Aspects 1-7, wherein the carrier assistance information is signaled via: at least a first unicast message with carrier assistance information specific to the first UE; and at least a second unicast message with carrier assistance information specific to the second UE.

Aspect 9: The method of any one of Aspects 1-8, wherein: the received information comprises sidelink control information (SCI) of at least one of the first UE or the second UE.

Aspect 10: The method of any one of Aspects 1-9, wherein signaling carrier assistance information to the first and second UEs comprises: signaling, via a first carrier, assistance information for at least a second carrier.

Aspect 11: A method for wireless communications by a first user equipment (UE), comprising: obtaining carrier assistance information indicating information for a future channel busy ratio (FCBR) one or more carriers on which at least a second UE is operating; and performing carrier selection for sidelink transmissions, based on the carrier assistance information.

Aspect 12: The method of Aspect 11, wherein the FCBR is calculated based on one or more future resource reservations inferred by the first UE or indicates resource reservations performed by the second UE.

Aspect 13: The method of any one of Aspects 11-12, wherein: the carrier assistance information is obtained from a network entity; and the carrier assistance information comprises FCBR information for at least one of the carriers associated with the second UE.

Aspect 14: The method of Aspect 13, further comprising: measuring FCBR information; and signaling the measured FCBR information to the network entity, wherein the carrier assistance information is based, at least in part, on the measured FBCR information.

Aspect 15: The method of any one of Aspects 11-14, wherein the carrier assistance information is obtained from at least a second UE.

Aspect 16: The method of Aspect 15, wherein the carrier assistance information is obtained by decoding sidelink control information (SCI) from the second UE.

Aspect 17: The method of Aspect 15, further comprising: providing, to the network entity, first FCBR information for at least one of the carriers associated with the first UE, wherein the carrier assistance information comprises FCBR information, for each carrier, consolidated, by the network entity, based on the first FCBR information and second FCBR information for at least one of the carriers associated with the second UE.

Aspect 18: The method of Aspect 17, further comprising: receiving a request for the first UE to provide the first FCBR information to the network entity.

Aspect 19: The method of Aspect 18, wherein: the request indicates one or more first carriers on which the first UE is to provide the first FCBR information; and the first FCBR information is provided via the one or more first carriers.

Aspect 20: The method of any one of Aspects 11-19, wherein obtaining the carrier assistance information comprises: obtaining, via a first carrier, assistance information for at least a second carrier.

Aspect 21: A network entity, comprising means for performing the operations of one or more of Aspects 1-10.

Aspect 22: A network entity, comprising a transceiver and a processing system including at least one processor configured to perform the operations of one or more of Aspects 1-10.

Aspect 23: An apparatus for wireless communications by a remote user equipment, comprising: an interface configured to obtain, from at least first and second user equipments (UEs), information regarding future resource reservations for sidelink transmissions on one or more carriers; and a processing system configured to calculate a metric for each of the carriers, based on the received information and signal carrier assistance information to the first and second UEs, based on the metric for each of the carriers.

Aspect 24: A computer-readable medium for wireless communications, comprising codes executable by an apparatus to: obtain, from at least first and second user equipments (UEs), information regarding future resource reservations for sidelink transmissions on one or more carriers; calculate a metric for each of the carriers, based on the received information; and signal carrier assistance information to the first and second UEs, based on the metric for each of the carriers.

Aspect 25: A first UE, comprising means for performing the operations of one or more of Aspects 11-20.

Aspect 26: A first UE, comprising a transceiver and a processing system including at least one processor configured to perform the operations of one or more of Aspects 11-20.

Aspect 27: An apparatus for wireless communications by a remote user equipment, comprising: an interface configured to obtain carrier assistance information indicating information for a future channel busy ratio (FCBR) one or more carriers on which at least a second UE is operating; and a processing system configured to perform carrier selection for sidelink transmissions, based on the carrier assistance information.

Aspect 28: A computer-readable medium for wireless communications, comprising codes executable by an apparatus to: obtain carrier assistance information indicating information for a future channel busy ratio (FCBR) one or more carriers on which at least a second UE is operating; and perform carrier selection for sidelink transmissions, based on the carrier assistance information.

The techniques described herein may be used for various wireless communications technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node such as a BS or UE may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, processors 258, 264 and 266, and/or controller/processor 280 of the UE 120a shown in FIG. 2 may be configured to perform operations 600 of FIG. 6 and processors 220, 230, 238, and/or controller/processor 240 of the BS 110a shown in FIG. 2 may be configured to perform operations 500 of FIG. 5.

Means for receiving may include a transceiver, a receiver or at least one antenna and at least one receive processor illustrated in FIG. 2. Means for transmitting, means for sending or means for outputting may include, a transceiver, a transmitter or at least one antenna and at least one transmit processor illustrated in FIG. 2. Means for calculating, means for signaling, means for consolidating, means for performing, and means for measuring may include a processing system, which may include one or more processors, such as processors 258, 264 and 266, and/or controller/processor 280 of the UE 120a and/or processors 220, 230, 238, and/or controller/processor 240 of the BS 110a shown in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 5-6.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a network entity, comprising:
receiving, from at least first and second user equipments (UEs), information regarding future resource reservations for sidelink transmissions on one or more carriers;
calculating a metric for each of the carriers, based on the received information; and
signaling carrier assistance information to the first and second UEs, based on the metric for each of the carriers.

2. The method of claim 1, wherein the metric comprises a future channel busy ratio (FCBR).

3. The method of claim 2, wherein the FCBR is calculated based on future resource reservations inferred by one of the first and second UEs or indicates resource reservations performed by at least one of the first and second UEs.

4. The method of claim 1, wherein:
the received information comprises first future channel busy ratio (FCBR) information for at least one of the carriers associated with the first UE and second FCBR information for at least one of the carriers associated with the second UE;
the method further comprises consolidating, for each carrier, the first FCBR information and the second FCBR information; and
the carrier assistance information comprises the consolidated FCBR information for each carrier.

5. The method of claim 4, further comprising:
signaling a first request for the first UE to provide the first FCBR information; and
signaling a second request for the second UE to provide the second FCBR information.

6. The method of claim 5, wherein:
the first request indicates a first one or more carriers on which the first UE is to provide the first FCBR information; and
the second request indicates a second one or more carriers on which the second UE is to provide the second FCBR information.

7. The method of claim 1, wherein the carrier assistance information is signaled via a broadcast message.

8. The method of claim 1, wherein the carrier assistance information is signaled via:
at least a first unicast message with carrier assistance information specific to the first UE; and
at least a second unicast message with carrier assistance information specific to the second UE.

9. The method of claim 1, wherein:
the received information comprises sidelink control information (SCI) of at least one of the first UE or the second UE.

10. The method of claim 1, wherein signaling carrier assistance information to the first and second UEs comprises:
signaling, via a first carrier, assistance information for at least a second carrier.

11. A method for wireless communications by a first user equipment (UE), comprising:
obtaining carrier assistance information indicating information for a future channel busy ratio (FCBR) one or more carriers on which at least a second UE is operating; and
performing carrier selection for sidelink transmissions, based on the carrier assistance information.

12. The method of claim 11, wherein the FCBR is calculated based on one or more future resource reservations inferred by the first UE or indicates resource reservations performed by the second UE.

13. The method of claim 11, wherein:
the carrier assistance information is obtained from a network entity; and
the carrier assistance information comprises FCBR information for at least one of the carriers associated with the second UE.

14. The method of claim 13, further comprising:
measuring FCBR information; and
signaling the measured FCBR information to the network entity, wherein the carrier assistance information is based, at least in part, on the measured FBCR information.

15. The method of claim 11, wherein the carrier assistance information is obtained from at least a second UE.

16. The method of claim 15, wherein the carrier assistance information is obtained by decoding sidelink control information (SCI) from the second UE.

17. The method of claim 15, further comprising:
providing, to the network entity, first FCBR information for at least one of the carriers associated with the first UE, wherein the carrier assistance information comprises FCBR information, for each carrier, consolidated, by the network entity, based on the first FCBR information and second FCBR information for at least one of the carriers associated with the second UE.

18. The method of claim 17, further comprising:
receiving a request for the first UE to provide the first FCBR information to the network entity.

19. The method of claim 18, wherein:
the request indicates one or more first carriers on which the first UE is to provide the first FCBR information; and
the first FCBR information is provided via the one or more first carriers.

20. The method of claim 11, wherein obtaining the carrier assistance information comprises:
obtaining, via a first carrier, assistance information for at least a second carrier.

21. A network entity, comprising:
a receiver configured to receive, from at least first and second user equipments (UEs), information regarding future resource reservations for sidelink transmissions on one or more carriers; and
a processing system configured to:
calculate a metric for each of the carriers, based on the received information; and
signal carrier assistance information to the first and second UEs, based on the metric for each of the carriers.

22. The network entity of claim 21, wherein the metric comprises a future channel busy ratio (FCBR).

23. The network entity of claim 22, wherein the FCBR is calculated based on future resource reservations inferred by one of the first and second UEs or indicates resource reservations performed by at least one of the first and second UEs.

24. The network entity of claim 21, wherein:
the received information comprises first future channel busy ratio (FCBR) information for at least one of the carriers associated with the first UE and second FCBR information for at least one of the carriers associated with the second UE;
the processing system is further configured to consolidate, for each carrier, the first FCBR information and the second FCBR information; and
the carrier assistance information comprises the consolidated FCBR information for each carrier.

25. The network entity of claim 24, wherein the processing system is further configured to:
signal a first request for the first UE to provide the first FCBR information; and
signal a second request for the second UE to provide the second FCBR information.

26. The network entity of claim 25, wherein:
the first request indicates a first one or more carriers on which the first UE is to provide the first FCBR information; and
the second request indicates a second one or more carriers on which the second UE is to provide the second FCBR information.

27. A first user equipment (UE), comprising:
an interface configured to obtain carrier assistance information indicating information for a future channel busy ratio (FCBR) one or more carriers on which at least a second UE is operating; and
a processing system configured to perform carrier selection for sidelink transmissions, based on the carrier assistance information.

28. The first UE of claim 27, wherein the FCBR is calculated based on one or more future resource reservations inferred by the first UE or indicates resource reservations performed by the second UE.

29. The first UE of claim 27, wherein:
the carrier assistance information is obtained from a network entity; and
the carrier assistance information comprises FCBR information for at least one of the carriers associated with the second UE.

30. The first UE of claim 29, the processing system is further configured to:
measure FCBR information; and
signal the measured FCBR information to the network entity, wherein the carrier assistance information is based, at least in part, on the measured FBCR information.
